(19) United States
(12) Patent Application Publication
(10) Pub. No.: US 2026/0135045 A1
(43) Pub. Date: May 14, 2026

(54) MANUFACTURING METHOD FOR ELECTRONIC DEVICE, AND MEDIA

(71) Applicant: SINTOKOGIO, LTD., Nagoya-shi (JP)

(72) Inventor: Masao HIRANO, Aichi (JP)

(73) Assignee: SINTOKOGIO, LTD., Nagoya-shi (JP)

(21) Appl. No.: 19/383,105

(22) Filed: Nov. 7, 2025

(30) Foreign Application Priority Data
Nov. 12, 2024 (JP) 2024-197327

(51) Int. Cl. H01G 13/00; H01G 4/30

(52) U.S. Cl. CPC H01G 13/00; H01G 4/30

(57) ABSTRACT

A manufacturing method for an electronic device includes: preparing an unfired or low-temperature-fired electronic device body composed of a ceramic material; barrel polishing the electronic device body; and firing the electronic device body after the barrel polishing. The barrel polishing is performed using media composed only of a material that sublimates at a temperature less than the temperature in the firing, and the firing includes sintering the electronic device body and burning off polishing debris generated by the barrel polishing.

### CROSS-REFERENCE TO RELATED APPLICATION

This application is based on Japanese Patent Application No. 2024-197327 filed with Japan Patent Office on November 12, 2024, the entire contents of which are hereby incorporated by reference.

### TECHNICAL FIELD

The present disclosure relates to a manufacturing method for an electronic device, and media.

### BACKGROUND

Japanese Patent Application Laid-Open No. 2003-324007 discloses a manufacturing method for a multilayer ceramic capacitor. In this manufacturing method, a laminate having a ceramic layer is polished by a barrel polishing apparatus. The polishing media are formed from silica, alumina, or both. A conductive paste layer for an external electrode is formed on the polished laminate, and the laminate on which the conductive paste layer has been formed is fired.

### SUMMARY

As in the manufacturing method described in Japanese Patent Application Laid-Open No. 2003-324007, an electronic device including a ceramic material is polished before firing. However, polishing debris containing a metallic element may chemically react during firing. The chemically reacted polishing debris may affect the quality of the electronic device. The present disclosure provides a technique that can prevent the quality of an electronic device including a ceramic material from deteriorating due to a chemical reaction involving polishing debris during sintering.

A manufacturing method for an electronic device according to one aspect of the present disclosure includes the following steps:

(1) preparing an unfired or low-temperature-fired electronic device body composed of a ceramic material;

(2) barrel polishing the electronic device body; and

(3) firing the electronic device body after the barrel polishing,

wherein the barrel polishing is performed using media composed only of a material that sublimates at a temperature less than the temperature in the firing, and

the firing includes sintering the electronic device body and burning off polishing debris generated by the barrel polishing.

Media according to another aspect of the present disclosure is used in the above-described manufacturing method for an electronic device.

According to the present disclosure, for an electronic device including a ceramic material, it is possible to avoid degradation of the quality of the electronic device due to a chemical reaction of polishing debris during sintering.

### BRIEF DESCRIPTION OF DRAWINGS

FIG. 1 is a flowchart illustrating a manufacturing method for an electronic device according to one embodiment.

FIG. 2A is a cross-sectional view of an exemplary electronic device body, and FIG. 2B is a cross-sectional view of an exemplary electronic device.

FIG. 3A is a schematic diagram of an exemplary barrel polishing apparatus, and FIG. 3B is a schematic diagram illustrating an example of a cross-section of a barrel tank.

### DETAILED DESCRIPTION

Hereinafter, embodiments of the present disclosure will be described in detail with reference to the drawings. In the description of the drawings, the same reference numerals are assigned to the same elements, and redundant descriptions are omitted. The dimensional ratios in the drawings do not necessarily match those in the description. The terms "upper," "lower," "left," and "right" are based on the state shown and are for convenience.

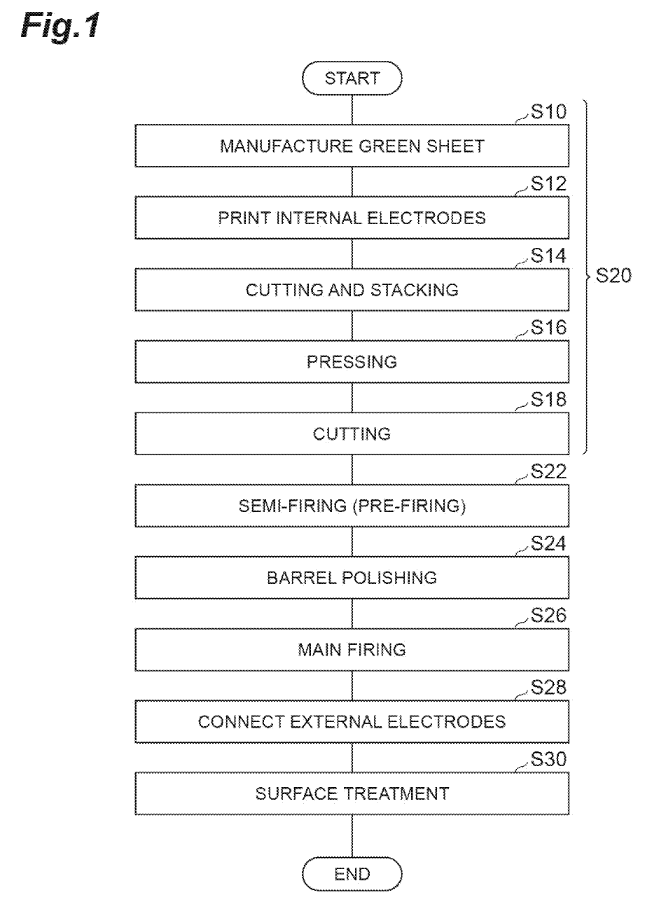

FIG. 1 is a flowchart illustrating a manufacturing method for an electronic device according to one embodiment. Electronic devices are basic components of electronic circuits and include resistors, capacitors, transistors, and the like. Hereinafter, as an example, a case where the electronic device is a multilayer ceramic capacitor (MLCC) will be described. The ceramic material is, for example, a barium zirconate-based or calcium zirconate-based material, and the electrode material is, for example, electrically conductive nickel. The multilayer ceramic capacitor has a size of, for example, 4 mm or less.

As shown in FIG. 1, in the manufacturing method, a green sheet is first manufactured (step S10). In step S10, a paste is prepared by mixing raw material powder of a ceramic dielectric and a binder. Next, the paste is spread as a sheet on a carrier layer made of resin to obtain a green sheet.

Subsequently, in step S12, internal electrodes are provided on the green sheet. In step S12, for example, a metal such as nickel is screen-printed on the green sheet.

Subsequently, in step S14, cutting and stacking are performed. First, the green sheet provided with the internal electrodes is cut to a predetermined size. Then, the electrode patterns of the cut sheets are aligned and stacked.

Subsequently, in step S16, pressing is performed. In step S16, the laminated sheet stack is pressure-bonded in the thickness direction and integrated.

Subsequently, in step S18, cutting is performed. In step S18, the pressure-bonded stack of sheets is cut to the size of a multilayer ceramic capacitor. Through the preparation process (step S20) from step S10 to step S18, a plurality of electronic device bodies are obtained from the pressure-bonded stack of sheets.

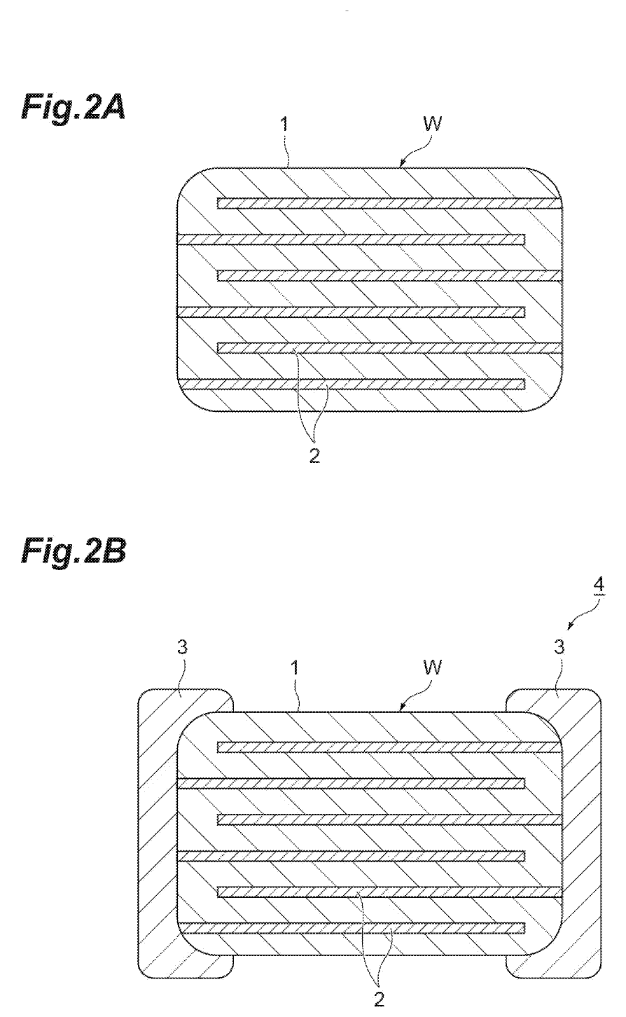

FIG. 2A is a cross-sectional view of an exemplary electronic device body. As shown in FIG. 2A, the electronic device body W is a chip-shaped component body and is composed of a ceramic material. The electronic device body W includes a ceramic dielectric 1 and a plurality of internal electrodes 2. Internal electrodes drawn out to one side surface of the ceramic dielectric 1 and internal electrodes drawn out to the other side surface are alternately arranged. Each internal electrode 2 is formed of, for example, nickel.

Returning to FIG. 1, in step S22, semi-firing (pre-firing) is performed using a firing furnace. Semi-firing is processed at a lower temperature than the main firing described later and is also referred to as low-temperature-firing. The semi-firing is performed, for example, at a temperature of 500°C or lower. As a result, the binder (such as a carrier layer made of resin) is expelled from the electronic device body W.

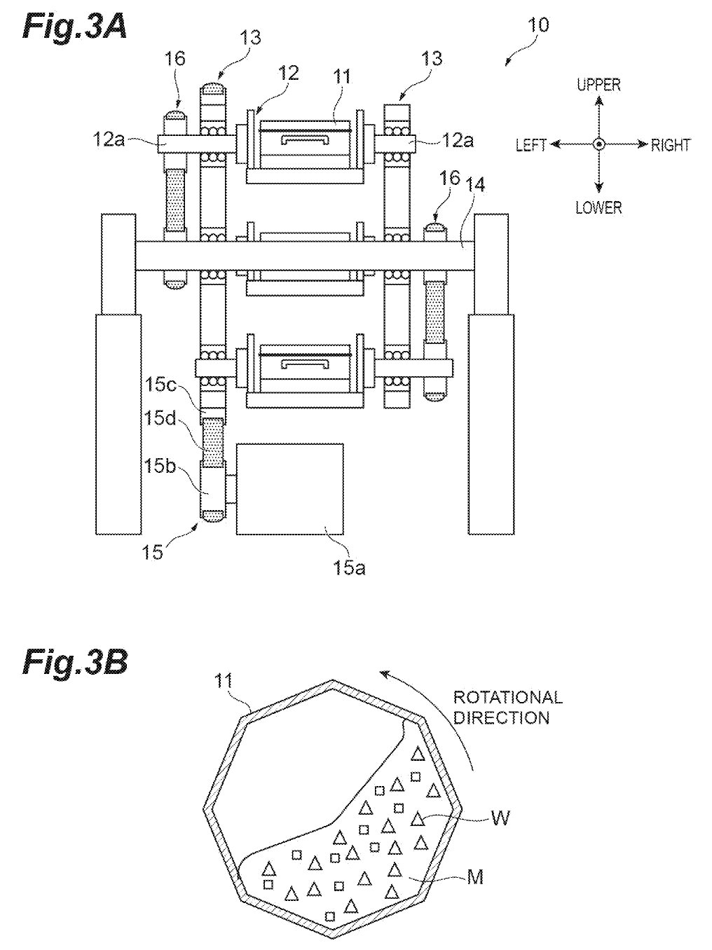

Subsequently, in step S24, barrel polishing is performed on the semi-fired electronic device body W. The barrel polishing is performed to chamfer the electronic device body W. The hardness of the ceramic increases due to the subsequent main firing. In this manufacturing method, by performing barrel polishing before hardening by the main firing, the electronic device body W is efficiently chamfered. That is, by performing barrel polishing while the electronic device body W is in a softer state than after the main firing, the electronic device body W is efficiently chamfered. The barrel polishing is performed, for example, using the barrel polishing apparatus shown in FIG. 3A. Here, barrel polishing is not limited to polishing by a barrel polishing apparatus. Barrel polishing also includes cases where a barrel polishing apparatus is not used, and includes polishing an object to be polished by putting a mass including the object to be polished and the media M into a container and then fluidizing the mass.

FIG. 3A is a schematic diagram of an exemplary barrel polishing apparatus. FIG. 3B is a schematic diagram illustrating an example of a cross-section of a barrel tank. As shown in FIG. 3A, the barrel polishing apparatus 10 includes a plurality of barrel tanks 11, a plurality of barrel tank cases 12, a pair of turrets 13 (revolving disks), a revolving shaft 14, a drive mechanism 15, and a driven mechanism 16. In the example shown in FIG. 3A, the barrel polishing apparatus 10 includes four barrel tanks 11. Three of the four barrel tanks 11 are illustrated. As shown in FIG. 3B, the electronic device body W and the media M are accommodated inside each of barrel tanks 11.

The media M are composed only of a material that sublimates at a temperature less than the temperature in the main firing step (step S26) described later. The temperature in the main firing step (step S26) is, for example, 800°C or higher, and a specific example is 1000°C to 1300°C. The media M are formed of, for example, an organic substance or a carbon-based material. The organic substance may be a naturally derived organic substance such as walnut, peach, maizo cob (corn cob), or potato starch, or a synthetic organic substance such as a thermoplastic resin or a thermosetting resin. The carbon-based material may be, for example, diamond. Diamond has the property of changing into CO₂ gas and sublimating at 800°C or higher. The media M may be bound by a binder. The binder is made of, for example, a polyester-based resin. Examples of materials for the binder include polyester, polyamide, ethylene-ethyl acrylate, and ethylene-vinyl acetate copolymer. The media M may have a size of 6 mm or less. In this case, the electronic device body W having a size of 4 mm or less can be appropriately polished.

Each of barrel tank cases 12 includes a rotation shaft 12a. The drive mechanism 15 includes a drive motor 15a, a motor pulley 15b, a revolving pulley 15c, and a drive belt 15d.

In the barrel polishing apparatus 10, when the drive motor 15a operates, driving force is transmitted to the turret 13 via the motor pulley 15b, the drive belt 15d, and the revolving pulley 15c, and the turret 13 rotates around the revolving shaft 14. Along with the rotation of the turret 13, each barrel 11 fixed to each of barrel tank cases 12 revolves around the revolving shaft 14 as an axis. Further, by the driven mechanism 16, each barrel 11 rotates on its own axis in a direction opposite to the rotational direction of the turret 13 around the rotation shaft 12a as an axis. As described above, each barrel 11 rotates on its own axis around the horizontally extending rotation shaft 12a and revolves around the horizontally extending revolving shaft 14. That is, each barrel 11 performs a planetary motion around a horizontally extending rotation axis.

Note that the barrel polishing apparatus used in the manufacturing method for an electronic device is not limited to the barrel polishing apparatus 10 shown in FIG. 3A. For example, the barrel polishing apparatus used in the manufacturing method for an electronic device may be any of a vibratory barrel polishing apparatus, a flow-type barrel polishing apparatus, a rotary barrel polishing apparatus, or a gyro-type barrel polishing apparatus.

Subsequently, in step S26, main firing is performed using a firing furnace. The main firing is performed at a temperature of 800°C or higher, as described above. As a result, the binder is further discharged from the electronic device body W, and the ceramic is formed. Furthermore, since the polishing debris generated by the barrel polishing is composed only of a material that sublimates at a temperature less than the temperature in the main firing step, it is burned off in the main firing step.

Thereafter, in step S28, as shown in FIG. 2B, external electrodes 3 are provided on both side surfaces of the electronic device body W. The external electrodes 3 are electrically connected to any of the plurality of internal electrodes 2. Thereafter, in step S30, a surface treatment such as plating is performed. As a result, the electronic device 4 is completed, and the flowchart shown in FIG. 1 ends.

### [Summary of Embodiment]

In the manufacturing method for the electronic device 4, the media M used for polishing the electronic device body W are composed only of a material that sublimates at a temperature less than the temperature in the main firing (step S26). As a result, the polishing debris is burned off during the main firing (step S26), and adhesion of metal or the like to the electronic device body W is avoided. Therefore, the quality of the electronic device 4 is improved.

### [Modifications]

Although various exemplary embodiments have been described above, the present disclosure is not limited to the above-described exemplary embodiments, and various omissions, substitutions, and changes may be made. For example, in the manufacturing method for the electronic device 4, the semi-firing may be omitted. That is, if the electronic device body W cut in step S18 has a strength that does not cause it to collapse during barrel polishing, after being cut in step S18, the barrel polishing of step S24 may be performed, followed by the main firing of step S26.

### Summary of Embodiments of the Present Disclosure

The present disclosure includes the following aspects.

### (Clause 1)

A manufacturing method for an electronic device according to one aspect of the present disclosure comprises: preparing an unfired or low-temperature-fired electronic device body composed of a ceramic material; barrel polishing the electronic device body; and firing the electronic device body after the barrel polishing, wherein the barrel polishing is performed using media composed only of a material that sublimates at a temperature less than the temperature in the firing, and the firing includes sintering the electronic device body and burning off polishing debris generated by the barrel polishing.

In this manufacturing method for an electronic device, the unfired or low-temperature-fired electronic device body is barrel polished. The barrel polishing is performed using media composed only of a material that sublimates at a temperature less than the temperature in the firing step. Then, the electronic device body after the barrel polishing is fired. As a result, the electronic device body is sintered, and the polishing debris generated by the barrel polishing sublimates and is burned off. Therefore, it is avoided that the polishing debris chemically reacts and metal or the like adheres to the electronic device body. In this way, the manufacturing method for an electronic device can prevent the quality of the electronic device from deteriorating due to a chemical reaction of the polishing debris during sintering.

### (Clause 2)

In the manufacturing method for an electronic device according to clause 1, the temperature in the firing may be 800°C or higher. In this case, the ceramic can be fired while reliably sublimating the media.

### (Clause 3)

In the manufacturing method for an electronic device according to clause 1 or 2, the media may be formed of an organic substance or diamond. In this case, the media can be sublimated as CO₂.

### (Clause 4)

In the manufacturing method for an electronic device according to any one of clauses 1 to 3, the media may have a size of 6 mm or less. In this case, an electronic device with a size of 4 mm or less is reliably polished.

### (Clause 5)

In the manufacturing method for an electronic device according to any one of clauses 1 to 4, the electronic device manufactured from the electronic device body may have a size of 4 mm or less.

### (Clause 6)

In the manufacturing method for an electronic device according to any one of clauses 1 to 5, the electronic device manufactured from the electronic device body may be a multilayer ceramic capacitor.

### (Clause 7)

Media according to another aspect of the present disclosure is used in the manufacturing method for an electronic device according to any one of clauses 1 to 6. By using this media, the manufacturing method for an electronic device can prevent the quality of the electronic device from deteriorating due to a chemical reaction of the polishing debris during sintering.

What is claimed is:

1. A manufacturing method for an electronic device, comprising:
preparing an unfired or low-temperature-fired electronic device body composed of a ceramic material;
barrel polishing the electronic device body; and
firing the electronic device body after the barrel polishing,
wherein the barrel polishing is performed using media composed only of a material that sublimates at a temperature less than the temperature in the firing, and
the firing includes sintering the electronic device body and burning off polishing debris generated by the barrel polishing.

2. The manufacturing method according to claim 1, wherein the temperature in the firing is 800°C or higher.

3. The manufacturing method according to claim 1, wherein the media are formed of an organic substance or diamond.

4. The manufacturing method according to claim 1, wherein the media have a size of 6 mm or less.

5. The manufacturing method according to claim 1, wherein the electronic device manufactured from the electronic device body has a size of 4 mm or less.

6. The manufacturing method according to claim 1, wherein the electronic device manufactured from the electronic device body is a multilayer ceramic capacitor.

7. Media used in the manufacturing method according to claim 1.
